(19) United States
(12) Patent Application Publication
(10) Pub. No.: US 2001/0047905 A1
(43) Pub. Date: Dec. 6, 2001

(54) Mobile device for providing elevation of a user above a supporting surface

(76) Inventor: Sean Boyer, Dalton, PA (US)

Correspondence Address: Sean Boyer, 5950 Drexel Road - Rear, Philadelphia, PA, 19131, US

(21) Appl. No.: 09/875,298

(22) Filed: Jun. 5, 2001

Related U.S. Application Data
(60) Provisional application No. 60/209,242, filed on Jun. 5, 2000.

(51) Int. Cl. E06C 1/00

(52) U.S. Cl. 182/15; 182/141

(57) ABSTRACT

A mobile device for releasably and adjustably supporting structures of varying dimensions that are capable of elevating a user above a supporting surface. The mobile device includes a plurality of wheels releasably and adjustably attached to the mobile device. The wheels include at least one driven wheel. The mobile device includes a driver for driving the at least one driven wheel. The driver is controllable by the user.

### CROSS-REFERENCE TO RELATED APPLICATIONS

This application claims priority from provisional application No. 60/209,242 filed Jun. 5, 2000, which is incorporated herein in its entirety.

### FIELD OF THE INVENTION

The subject invention relates generally to mobile devices capable of elevating a user above a supporting surface at different elevations. The mobile device of the present invention is capable of releasably and adjustably supporting structures of various sizes and shapes that are capable of elevating a user to varying elevations above a supporting surface. The mobile device includes a plurality of wheels. The wheels include at least one driven wheel. The mobile device includes a driver for driving the at least one driven wheel. The driver is controllable by the user.

### BACKGROUND OF THE INVENTION

U.S. Pat. No. 5,653,305 describes a non-adjustable non-steerable self-propelled step ladder. The '305 patent includes a variable speed motor and a specially designed step ladder having a single predetermined height.

There are other issued patents relating to self-propelled scaffold units. U.S. Pat. Nos. 3,865,203, 3,256,954, 3,930,548, 4,475,611, and 4,967,733 are illustrative of such patents.

U.S. Pat. No. 4,911,263 describes a non-adjustable non-steerable ladder of a single predetermined height having wheels attached thereto. Two of the wheels are manually actuated by a drive arm, while the other two wheels rotate freely.

It is desirable to provide a mobile device that not only performs the functions of the prior art more conveniently and efficiently but also performs functions not previously available which facilitate mobile access to varying elevations by releasably and adjustably supporting structures of varying dimensions and configurations capable of elevating a user to varying elevations above a supporting surface.

### SUMMARY OF THE INVENTION

In accordance with the present invention, there is provided a mobile device for releasably and adjustably supporting structures of various sizes and shapes that are capable of elevating a user to varying elevations above a supporting surface. The mobile device includes a plurality of wheels releasably and adjustably attached to the mobile device. The wheels include at least one driven wheel. The mobile device includes a driver for driving the at least one driven wheel. The driver is controllable by the user.

In an especially preferred embodiment, the invention provides a mobile base that can be used in conjunction with commercially available step ladders and is easily adjustable to accommodate various sizes of commercially available step ladders.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1 is a side elevation view of a mobile device in accordance with an embodiment of the present invention.

FIG. 2 is a side elevation view of a mobile base forming part of the mobile device of FIG. 1.

FIG. 3 is a plan view of the mobile base of FIG. 2.

FIG. 4 is a partial side view of a modified form of a supporting structure forming part of the mobile device of FIG. 1.

FIG. 5 is a view similar to FIG. 5, showing the supporting structure in a different configuration.

FIG. 6 is a partial perspective view of modified form of the mobile device of FIG. 1, including a lift in accordance with an embodiment of the present invention.

FIG. 7 is a rear elevation view of the mobile device of FIG. 1.

FIG. 7A is a detail of FIG. 7.

FIG. 8 is a side view of a mobile base in a folded or collapsed state.

### DETAILED DESCRIPTION OF THE INVENTION

For the sake of clarity, when describing the invention in the Detailed Description of the Invention, the term “mobile device” has been utilized to refer to the embodiment of the invention comprising a supporting structure and a mobile base, whereas the term “mobile base” has been utilized to refer to the embodiment of the invention comprising a mobile base that is capable of accepting a separate supporting structure but does not include the structure and does not necessarily have the structure currently attached thereto. It is therefore important to note, especially when reading the Field of the Invention, the Summary of the Invention, the Brief Description of the Drawings, and the Abstract, that the term “mobile device” may comprise a supporting structure and a mobile base or a mobile base that is capable of accepting a supporting structure but does not have the structure currently attached thereto.

Referring now to the figures wherein like reference numerals identify corresponding or similar elements throughout the several views, the present invention is illustrated in one or more configurations which are currently preferred.

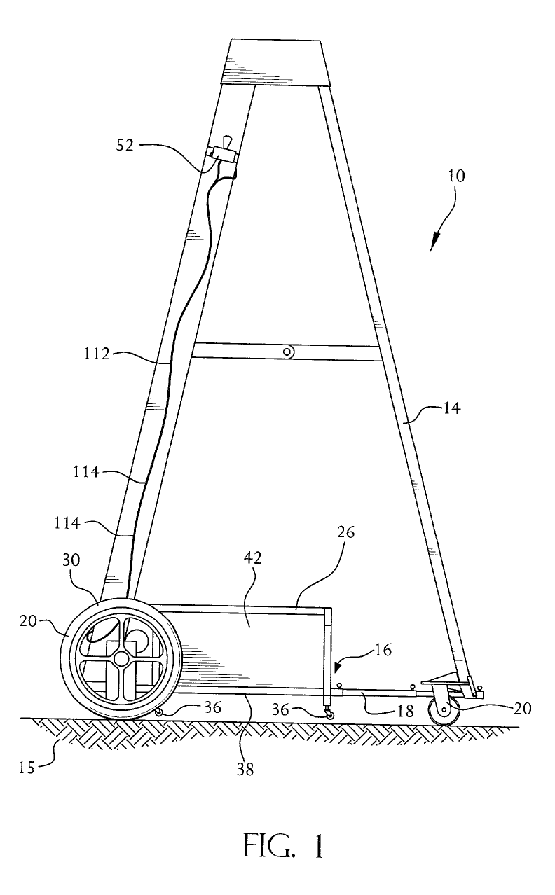

Referring initially to FIG. 1, one form of mobile device in accordance with the present invention, indicated generally by reference number 10, is shown for providing adjustable and controllable mobile access to varying elevations. The mobile device 10 includes a mobile base, indicated generally by the reference number 16, capable of releasably and adjustably engaging a supporting structure 14 that in turn is capable of elevating a user to varying elevations above a supporting surface 15. The mobile base 16 includes a plurality of releasable and adjustable wheels 20 with at least one being a driven wheel 30. As shown in FIGS. 1 to 3 of the drawings, two wheels 20, disposed co-axially to one another at either side of one end of the base 16, are driven wheels 30. In one embodiment, the wheels 20 are solid rubber wheel having a diameter sufficient to provide a smooth ride even on rough surfaces.

Supporting structures 14 capable of elevating users to various elevations above a supporting surface 15 may be constructed in many sizes and shapes according to the desired function, amount of elevation required, and other factors. The mobile base 16 of the present invention is adapted to accommodate such variety in supporting structures. A user can alter the length and width of the mobile base in minutes without tools. Such convenient adjustability allows the mobile base, in an embodiment where the supporting structure 14 is a step-ladder, to accommodate a wide variety of step-ladders. In one embodiment, the mobile base 16 is configured to accommodate 6 foot through 12 foot step-ladders (thereby providing a working height of 10 feet through 16 feet) with quick, simple and easy adjustments to the mobile base 16. In that embodiment, an accessory package may be provided to enable the mobile base 16 to accommodate step-ladders of 14 feet, 16 feet, and 20 feet. Note, that the size of the ladders described are described because they are the standard size of ladders currently being manufactured. The mobile base can be configured or adjusted to accommodate any size step-ladder.

The mobile base 16 of the present invention may be any configuration capable of releasably and adjustably engaging a supporting structure 14. For instance, in the embodiment of the present invention shown in FIGS. 1 to 3, the mobile base 16 includes a mobile frame 18, a mobile housing 26, and a mobile chassis 38. It will be understood by those skilled in the art that in a particular embodiment any one or more of the mobile frame 18, the housing 26, and the chassis 38, or any other suitable structure, may be used. Especially if a housing 26 is present, the base 16 may provide an accessible area for storing an internal power source, a microprocessor, assorted other control elements and working materials or tools of the trade, as well as providing a working surface.

The mobile base 16 has a unitized design and may be disassembled into small units easily handled by one person in minutes without the use of tools. This feature enables contractors and service people to single-handily load the mobile base 16 into their vehicles so as to facilitate cost efficient transportation of the mobile base 16 when changing job locations, leaving a shop, or retrieving their equipment. The ability of the mobile base 16 to be broken down into small units facilitate's the ability of those units to easily shipped thereby enabling efficient servicing and warranty operations.

The mobile base's 16 quiet operation and zero turning radius make it ideal for service work being performed in occupied areas. The mobile base 16 prevents undesirable movement through the use of, in one embodiment, automatic brakes. Bumper guards provide protection and make the mobile base 16 furniture friendly. The mobile base 16 may also includes a splash resistant cover to provide moisture protection if the mobile base 16 is being used during inclement weather or being utilized in some type of liquid washing operation. The mobile base 16, in one embodiment, has a ground clearance of two inches.

As previously mentioned, the mobile base 16 is adjustable in at least one dimension so as to enable the mobile base 16 to engage supporting structures of different sizes and configurations conveniently and efficiently. As shown in FIGS. 1 to 3, the mobile frame 18 comprises adjustable members 24 that are locked into position with pop-pins 25. The adjustable members 24 comprise tubular steel members that have rows of holes along them, and that fit into larger tubular members on which the pop-pins 25 are mounted. To adjust the base 16, a pop-pin 25 is withdrawn, a tubular member 24 with a row of holes is slid into or out of a larger tubular member 24 to a desired position, and the pop-pin 25 is inserted into a desired one of the row of holes.

As best seen in FIG. 3, the frame 18 consists of a central longitudinal frame member with transverse frame members front and rear. The wheels 20 are at the ends of the transverse frame members. The longitudinal frame member, and each half of each of the transverse frame members, consists of adjustable members 24. Therefore, to switch from a supporting structure 14 having one size to another supporting structure having a different size, whether it is smaller or larger, the width and length of the mobile base 16 can be easily adjusted, as necessary, and locked into place to safely accommodate the other supporting structure. Because both halves of each of the transverse frame member are adjustable, the width of the base 16 can be adjusted symmetrically about the housing 26 and the center of gravity of the base 16. Although pop-pins are described herein as the mechanism for locking the adjustable steel members 24 in place, any type of locking mechanism and corresponding member, steel or otherwise, may be utilized to achieve the requisite adjustability, as is evident to those skilled in the art.

As shown in the drawings, the chassis 38 includes a first receptacle 28 attached to the mobile housing 26 and the telescoping frame 18 includes a second receptacle 32. The mobile housing 26, at the first receptacle 28, adjustably receives the steel members 24 of the rear transverse frame member, secured in place by a pop-pin 25. The second receptacle 32 connects the telescoping longitudinal member of the frame 18 to the front transverse frame member, the ends of which releasably and adjustably engage wheels 20 in the form of casters 34.

Associated with each of the wheels 20 is a platform 35, which moves with the associated wheel as the size of the base 16 is adjusted. The platforms 35 are adapted to engage and support a supporting structure 14 capable of elevating a user above a supporting surface 15. As shown in FIGS. 1 to 3, the supporting structure 14 may be a commercially available step-ladder. The separation between the feet of a step ladder varies and, in particular, the distance from the front feet to the back feet is correlated to the height of the step ladder. Thus, by adjusting the length of the longitudinal frame member 24, and if necessary, the width of the front and rear transverse members, the device may be adapted to support step-ladders of different heights.

Each of the platforms 35 is provided with a locking mechanism 37 to secure the supporting structure 14 to the mobile base 16. In one embodiment, the locking mechanism utilized to releasably engage the supporting structure 14 is a clamp welded to the platform that is similar in operation to a standard set of Vise-Grip locking pliers. In particular, it has both a screw adjustment and a quick lever action to clamp and release it. When the supporting structure 14 is in position on the platforms 35, the clamps are fastened, clamping the feet or legs of the supporting structure.

In another embodiment, the locking mechanisms 37 are self-locking devices similar to the clamps on skis. When a foot of a supporting structure 37 is placed on the platform 35, it actuates the self-locking device, which automatically secures the foot to the platform. In one embodiment, the self-locking devices are similar to those on a pair of skis. This embodiment is especially suitable for a conventional fiberglass step ladder, having C-section channel legs that are closed at the bottom by flat feet. The self-locking mechanism can then be positioned to close onto the upper surfaces of the feet, clamping them down onto the platforms 35.

The mobile housing 26 includes a panel that is openable so as to provide access to an interior area 42 of the chassis. In a preferred embodiment, the interior area may serve as a full-sized tool box approximately 24 inches in length. In this embodiment, the top surface of the housing 26 is openable so as to provide convenient access to the interior area 42. The housing 26 may have open or openable sides and/or an open or openable front and/or back. The openable side may be in the form of a flexible curtain. The interior area 42 could serve as a place to put working materials such as light bulbs or strings of holiday lights while decorating a mall or department store for example. Instead, or in addition, the top of the housing 26 may form a tray for storage of tools or materials.

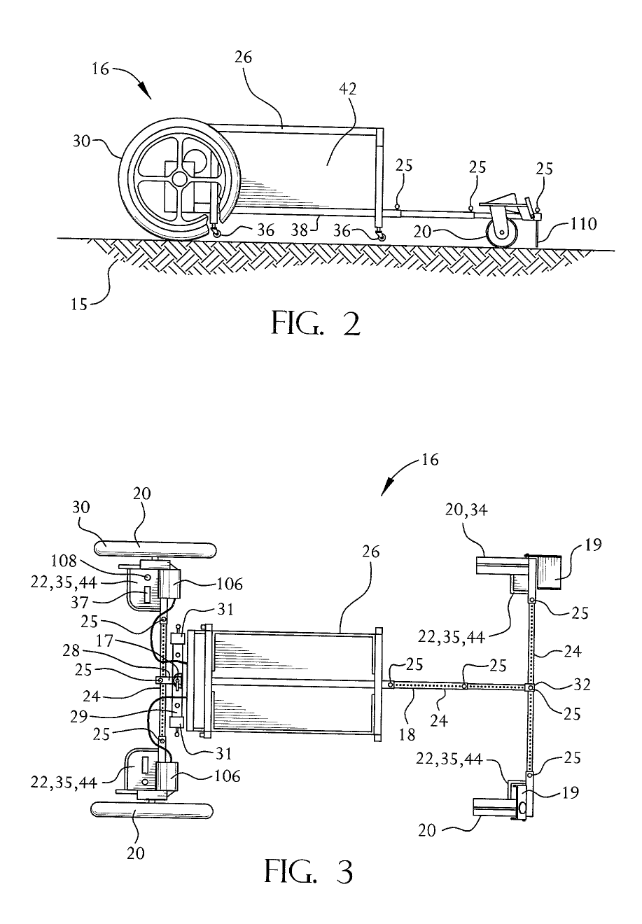

As shown in the drawings, the supporting structure 14 includes a plurality of graduated steps 46. In FIGS. 1 and 2, the supporting structure 14 includes an A-frame configuration, but it may be of any suitable configuration capable of elevating a user above the supporting surface 15. The supporting structure 14 may be telescoping or collapsible or extendible. The supporting structure 14 is not limited to having four legs, but rather may have any number of legs for supporting a plurality of graduated steps 46 or otherwise capable of elevating a user to varying elevations above a supporting surface 15.

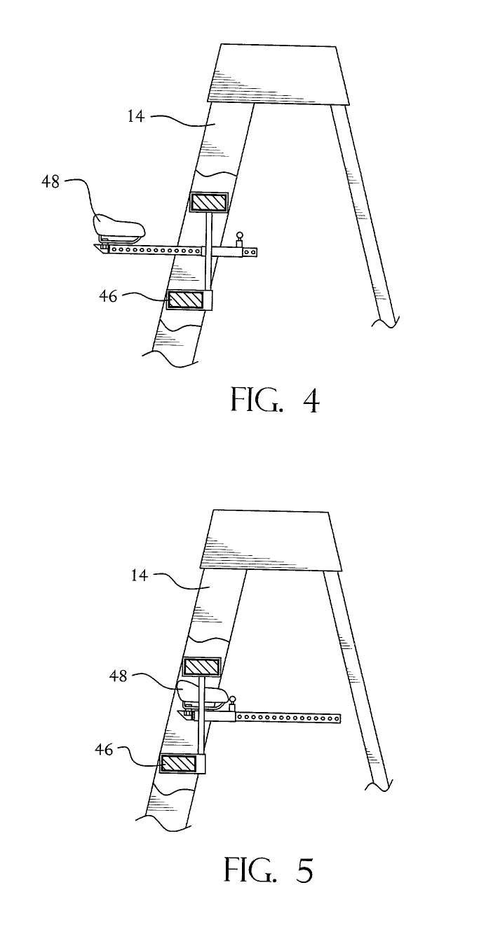

Referring now to FIGS. 4 and 5, the supporting structure 14 includes, in a preferred embodiment, an adjustable seat 48 releasably attached to the supporting structure 14. When desired the adjustable seat 48 may be extended so as to protrude out from the supporting structure 14 and provide a surface on which a user may sit (see FIG. 4). When not in use, the adjustable seat 48 slides into the interior of the supporting structure 14, so as to be out of the way when a user is climbing up or down the exterior of the supporting structure (see FIG. 5).

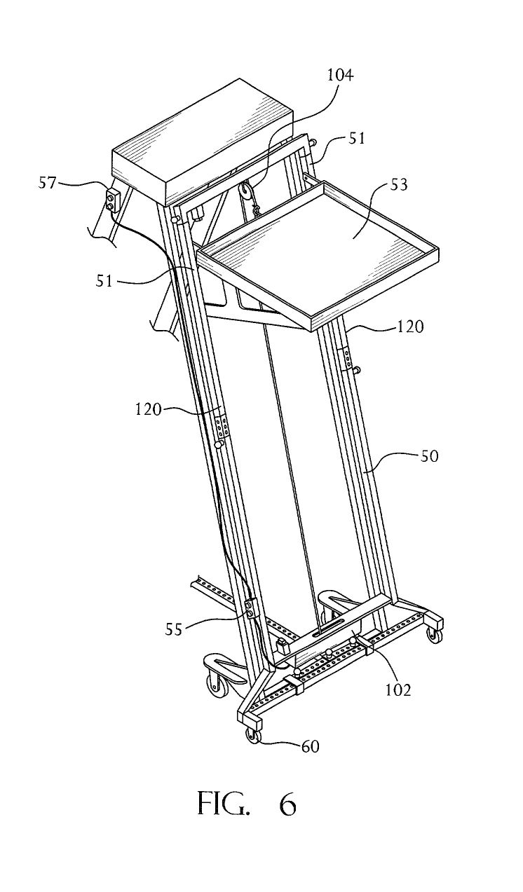

Referring to FIG. 6, the mobile device 10 may include a releasably attached lift 50 for lifting materials up and down as desired by the user. The lift 50 includes rails 51 for a tray 53 to ride up and down. By way of example, the lift 50 is shown powered electro-mechanically with a winch 102 and pulley 104. The winch 102 is powered by an internal power source. In one embodiment the internal power source may be a battery 47 contained in the mobile base 16. One benefit of utilizing battery 47 power as the internal power source is that the weight of the battery 47 provides stability to the mobile device 10. The lift 50 is controllable by the user. For convenience, two controllers are provided. A first controller 55 is attached near the bottom of one of the rails 51, and allows a user to control the lift 50 when the user is at ground level, on the supporting surface 15. A second controller 57 is removably attached to the supporting structure 14, near the top of the supporting structure, and allows a user to control the lift 50 when the user is up the supporting structure 14. The rails 51 may include modular sections 120, to allow the lift 50 to be adapted to supporting structures 14 of different heights.

While the lift 50 is shown powered electro-mechanically, the lift 50 may be powered by any means including, for example, hydraulics. The lift 50 also includes at least one wheel, in the form of a pair of casters 60, so as to lessen the load imposed upon the casters 34 by the lift 50. Another embodiment may include a tray, basket, tool box, or other apparatus for carrying working materials. Such items may be releasably and hingedly attached to the supporting structure 14. Such items are typically provided on the back side of a step ladder i.e. the side opposite that which a user ascends. Where the supporting structure 14 is a step ladder, another accessory such as a working-platform releasably attached to the front of the step ladder, i.e. the side a user ascends, may be provided so as to provide a working-platform on which a user may stand. Such a working-platform provides a user with an enhanced level of safety as well as the option of standing on the working-platform as opposed to one of the ladder's steps when working at a particular elevation for an extended period of time. The working-platform may be attached to the step ladder at any elevation as desired.

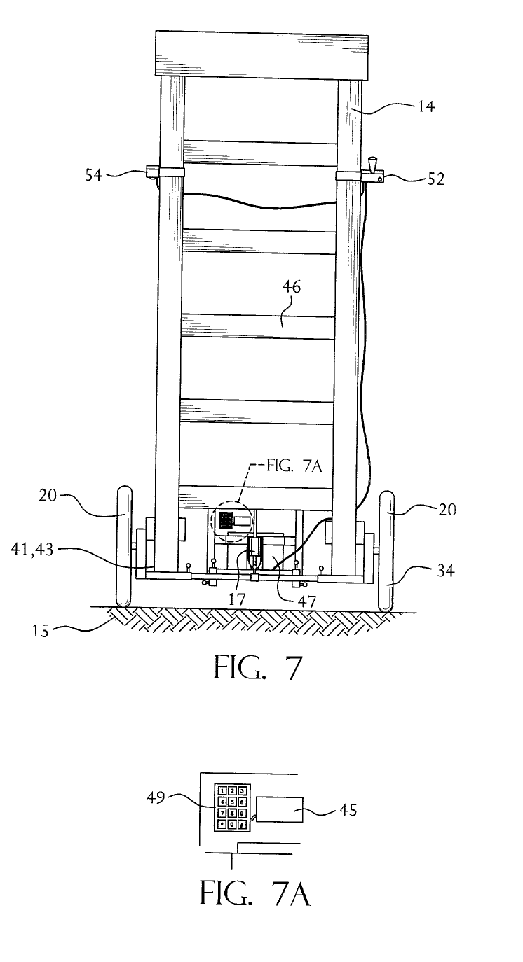

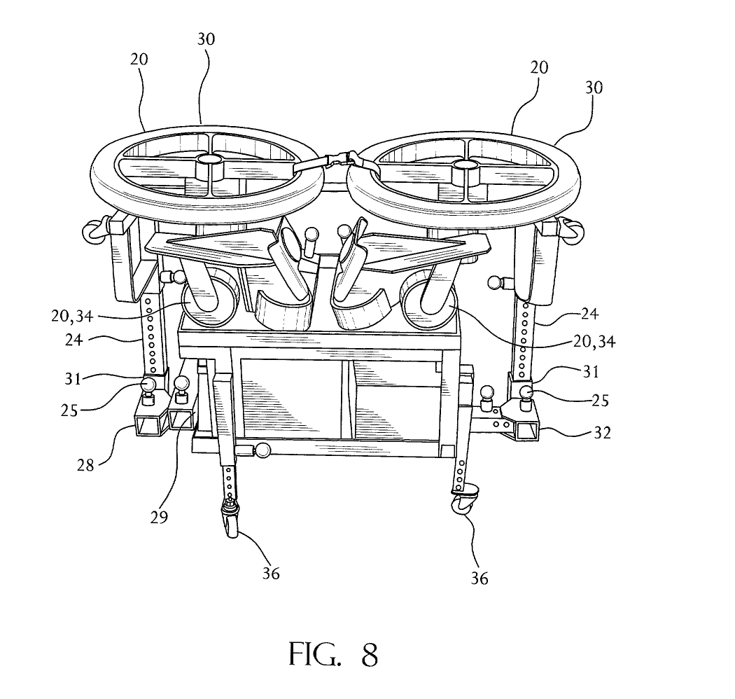

As described above, the mobile base 16 includes a pair of driven wheels 30. The driven wheels 30 are powered by the battery 47 (see FIG. 7) or, depending upon the embodiment, other internal power source. For convenience, an on-board charger may be provided to replenish the mobile device's internal power source without disassembly. At least one controller 52 is provided for controlling the driven wheels 30. The controller 52 is capable of being releasably attached to either the supporting structure 14 or the mobile base 16.

In one embodiment, the driven wheels 30 are controlled by a switch activated joystick 52 together with a switch 54 for activating the joystick 52. The joystick is an ambidextrous controller that can be mounted on the either side of the supporting structure 14 or mobile base 16. When mounted on the supporting structure 14, the joystick may be mounted at any height. Regardless of where the joystick 52 is located, the switch 54 may normally be mounted on an opposite side. As a safety mechanism, the joystick 52 and the switch 54 are so connected that the mobile device 10 will move only when they are both activated, and are both biased so as to be normally in an inactive position. Thus, the user can cause the mobile device to move only when the user is centrally positioned on the supporting structure 14 with one hand on each side rail. This arrangement also prevents the mobile device 10 or, where the supporting structure is not attached, the mobile base 16 from moving as a result of accidental contact with the joystick 52.

If the joystick 52 or the switch 54 is released while the mobile device 10 is in motion, it automatically and safely decelerates at a pre-selected rate. During deceleration, the brakes are automatically actuated. For operator convenience, the controller is adapted to releasably engage the mobile device 10 at either the mobile base 16 or the supporting structure 14. In one embodiment, the controller is attached by way of screw clamps for easy removal and attachment. The at least one controller need not include a joystick 52 but may be any controller capable of conveniently and efficiently operating and controlling the movement of the mobile device 10 by controlling the drive to the driven wheels 30. In one embodiment, the at least one controller, joystick or otherwise, comprises a lockout key switch, a power switch and a button for activating a horn.

As shown in FIG. 3, each of the driven wheels 30 is driven by a separate motor 106. By activating each of the motors 106 independently, the mobile device 10 may be caused to move forwards or backwards and/or to rotate, with the casters 34 swiveling to accommodate rotation of the mobile base 16. Joystick control of a vehicle having two independently driven wheels and two casters is well known and, in the interests of conciseness, will not be further discussed here.

In a preferred embodiment, the mobile device 10 includes a user interface 49 to facilitate data input by the user, a microprocessor 45, and at least one sensor 41. The user interface 49, microprocessor and at least one sensor 41 are utilized to regulate movement of the mobile device 10. The microprocessor 45 and user interface 49 may be programmed to calibrate the movements of the mobile device 10 according to a particular user's physical characteristics or operational preferences. A user, who is using the mobile device 10 for the first time may enter via the user interface 49 an identifier as well as their height, weight and any other physical attributes or disabilities that could potentially affect their ability to operate the mobile device 10. Subsequent use of the device 10 by that user would simply require the user to enter their identifier.

The physical characteristics or operational preferences which the microprocessor 45 will accept, and alter operation as a result of, may be pre-selected as desired. For example, the microprocessor 45 may be programmed to accept a user's height and weight. In that instance, the user, prior to operating the mobile device 10 for the first time, would enter their name or other pre-programmed identifier and their height and weight. The user may also be prompted to enter the characteristics of the supporting structure 14 being utilized. The microprocessor 45 will control the operation of the device 10 as a result of that data. For example, the microprocessor 45 may be programmed to limit the maximum speed at which the device 10 will travel for individuals above a pre-selected weight, in dependence on the size of the supporting structure 14 being utilized, so as to maximize safe operation of the mobile device 10.

The user interface 49 is shown as a numeric keypad but may be any user interface and may, in particular, be an alpha-numeric interface. The type of interface utilized will depend on the data which the microprocessor 45 is programmed to receive, as is readily understood by those skilled in the art.

The microprocessor 45 may also be connected to at least one sensor 43 to regulate movement of the mobile device 10. For example, sensors 108 may be placed at locations where the mobile base 16 of the mobile device 10 engages a supporting structure 14 and programmed to send a signal to the microprocessor 45 disabling the at least one driven wheel 30 when the supporting structure 14 is not properly attached to the mobile base 16. Feelers 110 may be provided at the corners of the mobile base 16, to sense the presence of the supporting surface 15 before the wheels 20 run onto that part of the supporting surface 15. The mobile device 10 may then be stopped automatically if it approaches a step down or a sudden drop in the ground that might prejudice the stability of the device. In other embodiments, proximity or infra red sensors may be used instead of feelers 110, as could other methods and devices, for sensing the presence of a supporting surface 15.

A cable 112 connected to the joystick 52 may consist of short sections 114 with significant resistance. In order to position the joystick 52 at the top of the support device 14, the user then assembles a sufficient number of sections 114 for the height of the supporting device 14. The microprocessor can then sense the resistance of the assembled cable 112, and deduce the height of the support device 14. In one embodiment, the sections 114 are in two foot sections wherein each section incorporates an in-line resistor of a predetermined fixed value. The sum of the resistance of any number of those sections 114 can be read by the microprocessor 45 to determine the total combined length of a control cable 112 and thus the height of the supporting structure 14 currently being used. For example, if the resistors are each 1 ohm, and the microprocessor 45 reads a total of 6 ohms, then the height of the supporting structure 14 being used is 12 feet. The microprocessor concludes the supporting structure 14 is 12 feet in this situation because six two foot sections 114 are being used to attain a height of 12 feet with a combined resistance of 6 ohms.

Cable sections 114 are used not only for control wiring but also for power wiring. Connecting the various cable sections 114, in one embodiment, is accomplished through the use of quick connectors. All the connections may be color-coded quick disconnect type connections for both the control cables and the power cables.

The mobile base 16 is separable from the supporting structure 14 and the mobile base 16 may be operated without the supporting structure 14 being attached thereto. When the supporting structure 14 is not attached, the controller 52 and the switch 54 may simply be reattached to the mobile base 16 itself, thereby enabling a user to easily transport the mobile base 16 from one working area to another in situations where traveling to another working area is not possible or otherwise inappropriate with the supporting structure 14 attached to the mobile base 16. When operating the mobile base 16 without the supporting structure 14, a user may sit on top of the mobile housing 26. To further facilitate convenient operation of the mobile base 16 when the supporting structure 14 is not attached thereto, foot rests 19 are provided. The foot rests 19 are hinged, so that they can be folded up out of the way when not in use. Referring to FIG. 3, one foot rest is shown as extended down toward the supporting surface 15 and a second foot rest is shown positioned upward away from the supporting surface 15 and in towards the mobile base 16.

The mobile base 16, in addition to being capable of being disassembled into small units, is also foldable and collapsible thereby providing convenient short-term storage. See FIG. 8. In one embodiment, the mobile base 16 can be reduced so as to have a length of 43″, a width of 20″ and a height of 33″. When the mobile base is collapsed, the longitudinal frame member 24 telescopes in under the mobile housing 26. Each wheel 20 and its associated platform 35 is detached as a unit. The rear wheel units include the motors 106, still connected to the driven wheels 30. Thus, only the electrical feeds to the motors 106 need to be disconnected, making disassembly and reassembly very simple. The transverse frame members 24 are detached from the receptacles 28 and 32. Adapters 31 are removed from a supporting frame member 29 and inserted into those receptacles 28, 32. The transverse frame members 24 are then inserted into the adapters 31 so that they are vertical with respect to the supporting surface 15 and mobile base 16. Once the transverse fame members 24 are in place, the driven wheels 30 are attached to those transverse frame members 24. The remaining wheels are also supported by the mobile housing 26 as shown in FIG. 8.

As explained above, when the mobile base 16 is collapsed as shown in FIG. 8, all of the detached elements of the mobile base 16 are supported by the mobile housing 26, which is equipped with mountings for them. Caster wheels 36 included on the mobile housing 26 facilitate convenient manual transportation of the mobile base 16 while it is in a collapsed or folded or otherwise compact state. Those wheels 36 cause the mobile base 16, while in the folded, collapsed, or otherwise compact state, to be elevated and free-rolling thereby allowing the mobile base 16 to be conveniently pushed through aisles as narrow as 21 inches. The caster wheels 36 are retracted upwards when not in use.

To further facilitate convenient collapsing of the mobile base, an elevator or other lifting mechanism is provided. In a preferred embodiment, the elevator is a manually operated jack 17 that is provided to allow a user to elevate or lower the mobile base 16 as required so as to enable the wheels 20 and the transverse frame members 24 to be removed as desired. The jack 17 is releasably attached to the supporting frame member 29 when not in use.

Although embodiments of the invention have been described in detail, it is to be understood that the invention is not limited thereto, and that various changes can be made therein without departing from the spirit and scope of the invention, which is defined by the attached claims.

What is claimed is:

1. A mobile device for providing elevation of a user above a supporting surface, the device comprising:
a structure supported by a mobile base, the structure being separable from the mobile base and adapted to elevate a user to varying elevations;
the mobile base comprising a mobile frame adapted to adjustably engage a plurality of releasably attached wheels, the plurality of wheels being adjustable in at least one dimension and including at least one driven wheel;
the mobile frame adapted to releasably engage the structure supported by the mobile base and adjustable in at least one dimension to releasably engage a different structure to be supported by the mobile base; and
a driver for driving the at least one driven wheel, the driven wheel being controllable by the user.

2. A mobile device as in claim 1, wherein the mobile frame further comprises at least one telescoping receptacle for adjustably engaging at least one of the plurality of releasably attached wheels wherein the wheels are adapted to releasably engage the structure supported by the mobile base.

3. A mobile device as in claim 1, wherein the mobile base further comprises an elevator to facilitate removal of the plurality of wheels.

4. A mobile device as in claim 1, wherein the mobile base is collapsible for storage and transport when the mobile base is not attached to the structure supported by the mobile base.

5. A mobile device as in claim 1, wherein the structure supported by the mobile base further comprises a releasably attached seat slidably engaged with the structure.

6. A mobile device as in claim 1, wherein the mobile base further comprises a releasably attached structure having a lift for elevating material, the lift being controllable by the user.

7. A mobile device as in claim 1, further comprising a user interface for inputting data, a microprocessor, and at least one sensor; the user interface, microprocessor and at least one sensor being adapted to regulate the movement of the mobile device according to the characteristics of a person using the device and the size of the structure supported by the mobile base.

8. A mobile device as in claim 1, further comprising at least one sensor adapted to prohibit movement of the mobile device if the structure supported by the mobile base is not properly attached to the mobile base.

9. A mobile device as in claim 1, wherein the controllable at least one driven wheel is controlled by at least one remote control.

10. A mobile device as in claim 9 wherein the at least one remote control comprises a switch activated controller and a switch for activating the switch activated controller.

11. A mobile device as in claim 1, wherein the height of the structure supported by the mobile base is in the range from approximately three feet to approximately twenty-four feet.

12. A mobile device as in claim 1, wherein the structure supported by the mobile base includes a plurality of graduated steps.

13. A mobile base for supporting a structure capable of elevating a user above a supporting structure, the base comprising:
a mobile housing;
a first receptacle attached to the mobile housing, the receptacle being adapted to releasably and adjustably engage at least one driven wheel, the driven wheel being adjustable in at least one dimension;
a second receptacle telescopically attached to the mobile housing, the receptacle being adapted to releasably and adjustably engage at least one wheel, the wheel being adjustable in at least one dimension;
the at least one driven wheel and the at least one wheel being adapted to releasably and adjustably engage and support a structure capable of elevating a user above a supporting surface; and
a driver for driving the at least one driven wheel, the driver being controllable by the user.

14. A mobile base as in claim 13, further comprising an elevator to facilitate removal of the at least one driven wheel and the at least one wheel.

15. A mobile base as in claim 13, wherein the mobile base is collapsible for storage and transport.

16. A mobile base as in claim 13, wherein the mobile base further comprises a releasably attached structure having a lift for elevating material from a supporting surface to a user, the lift being controllable by the user.

17. A mobile base as in claim 13, adapted to support a structure comprising a plurality of graduated steps, and adjustable to receive structures ranging in height from approximately three feet to approximately twenty-four feet and in width from approximately two feet to approximately seven feet.

18. A mobile base as in claim 17, further comprising a user interface for inputting data, a microprocessor, and at least one sensor; the user interface, microprocessor, and at least one sensor being adapted to regulate the movement of the mobile base according to the characteristics of the user and the size of the structure carrying a plurality of graduated steps.

19. A mobile base as in claim 17, further comprising at least one sensor adapted to prohibit movement of the mobile base if the structure carrying a plurality of graduated steps is not properly attached to the mobile base.

20. A mobile base as in claim 13, wherein the controllable at least one driven wheel is controlled by at least one remote control.

21. A mobile base as in claim 20, wherein the at least one remote control comprises a switch activated controller and a switch for activating the switch activated controller.

22. A mobile base for supporting a structure capable of elevating a user above a supporting surface, the mobile base comprising:
a mobile chassis adapted to be openable so as to provide access to an interior area of the chassis;
at least one platform attached to the chassis for releasably and adjustably supporting a structure capable of elevating a user above a supporting surface, the at least one platform being adjustable in at least one dimension;
a plurality of wheels releasably attached to the chassis with at least one wheel being a driven wheel, the plurality of wheels being adjustable in at least one dimension; and
a driver for driving the at least one driven wheel, the driver being controllable by the user.

23. A mobile base as in claim 22, further comprising an elevator to facilitate removal of the plurality of wheels.

24. A mobile base as in claim 22, wherein the mobile base is collapsible for storage and transport.

25. A mobile base as in claim 22, wherein the mobile base further comprises a releasably attached lift, the lift being controllable by the user.

26. A mobile base as in claim 22, further comprising a structure adapted to elevate a user to varying elevations, the structure being adjustably and releasably attached to the mobile base.

27. A mobile base as in claim 26, wherein the structure adapted to elevate a user to varying elevations further comprises a plurality of graduated steps.

28. A mobile base as in claim 26, wherein the movement of the mobile base is regulated according to the preferences and physical characteristics of the user and the size, shape and configuration of the structure adapted to elevate a user to varying elevations.

29. A mobile base as in claim 26, comprising at least one sensor for prohibiting movement of the mobile base if the structure is not properly attached to the mobile base.

30. A mobile base as in claim 22, wherein the controllable at least one driven wheel is controlled by the user with a plurality of remote controls.

31. A mobile base as in claim 30, wherein the plurality of remote controls include a switch activated controller and a switch for activating the switch activated controller.

32. A mobile device for providing elevation of a user above a supporting surface, the device comprising:
a mobile base comprising a plurality of wheels including at least one driven wheel, and a drive controllable by the user for driving the at least one driven wheel;
a structure supported by the mobile base, the structure being separable from the mobile base and adapted to support a user above the base;
the mobile base being adapted to releasably and adjustably engage the structure at a plurality of locations on the mobile base;
the mobile base being adjustable to change the relative positions of said locations at which said base is adapted to engage the structure.

33. The mobile base of claim 32, wherein each said location is associated with one of said plurality of wheels, and wherein said base is adjustable such that each said wheel moves with its associated said location.

34. The mobile base of claim 33, further comprising an elevator for lifting the base off the ground to facilitate removal of the plurality of wheels.

35. The mobile base of claim 32, wherein each said location is adjustably connected to a central part of said base.

36. The mobile base of claim 32, wherein said central part is a body, a frame, or a chassis.

37. The mobile base of claim 32, further comprising at least one telescoping receptacle for adjustably engaging at least one of the plurality of locations.

38. The mobile base of claim 32, wherein said locations and said wheels are detachable for storage and transport.

39. The mobile base of claim 38, further comprising casters for supporting the base when the wheels have been detached.

40. The mobile device of claim 32, further comprising a user interface for inputting data, a microprocessor, and at least one sensor; the user interface, microprocessor and at least one sensor being adapted to regulate the movement of the mobile device according to characteristics of a person using the device and the size of a structure supported by the mobile base.

41. The mobile device of claim 32, further comprising at least one sensor adapted to prohibit movement of the mobile device if the structure supported by the mobile base is improperly attached to the mobile base.

42. The mobile device of claim 32, wherein the drive is controlled by at least one remote control that comprises a controller and a separate switch for activating the controller, and wherein the controller and the separate switch are adapted to be disposed at opposite sides of the mobile base.

43. The mobile base of claim 32, wherein the mobile base is adapted to support a step ladder, with the feet of the step ladder at said plurality of locations, and said locations are adjustable to receive step ladders in the range from approximately three feet to approximately twenty-four feet.
